(19) United States
(12) Patent Application Publication
(10) Pub. No.: US 2010/0083655 A1
(43) Pub. Date: Apr. 8, 2010

(54) TURBOCHARGER SYSTEM AND METHOD

(76) Inventors: Mark S. Frederick, Canaan, NY (US); Doug Guerineau, Troy, NY (US); Norbert B. Abraham, JR., Grove City, PA (US); Eric Premo, Troy, NY (US)

Correspondence Address: General Electric Company;GE Global Patent Operation, 2 Corporate Drive, Suite 648, Shelton, CT, 06484, US

(21) Appl. No.: 12/615,457

(22) Filed: Nov. 10, 2009

Related U.S. Application Data
(63) Continuation-in-part of application No. 11/536,800, filed on Sep. 29, 2006, now abandoned.

(51) Int. Cl. F02B 33/44

(52) U.S. Cl. 60/608

(57) ABSTRACT

A turbocharger system for an engine (e.g., a diesel engine in a locomotive) includes a turbocharger unit and a fixed gear assembly. The turbocharger unit comprises a compressor for providing compressed air to an intake of the engine, a turbine driven by an exhaust of the engine, and a shaft interconnecting the turbine and compressor. The fixed gear assembly interconnects an engine gear train of the engine to the turbocharger unit for driving the turbocharger unit. There is no turbocharger clutch mechanism in the turbocharger system, engine, or otherwise in the vehicle. Thus, the fixed gear assembly operates to drive the turbocharger unit whenever the engine gear train is operational.

This application is a continuation-in-part and claims priority to U.S. application Ser. No. 11/536,800, filed Sep. 29, 2006.

### FIELD OF INVENTION

This invention relates generally to turbochargers.

### BACKGROUND OF THE INVENTION

Conventionally, turbochargers are operably connected to an internal combustion engine in which exhaust gas from the engine is utilized to increase the pressure of air above ambient to the engine. In a typical turbocharger, a turbine is driven by engine exhaust gas. The turbine then drives a compressor that draws in ambient air and increases the pressure of intake air provided to the engine. This permits more fuel to be burned in the cylinder and, therefore, the expanding products of combustion will exert more force on the piston during each power stroke.

The main advantage of a turbocharger is that it increases the power output of a diesel engine. However, the addition of the turbocharger to the engine also increases the complexity of the operation of the engine and its control and maintenance. Typically, the turbocharger includes a shaft, a driving turbine or expander attached at one end of the shaft, and a compressor attached to the other end of the shaft. The expander is attached to the engine to receive exhaust gases from the engine and the compressor is attached to an air intake manifold of the engine. During operation, the expander receives exhaust gas which causes the shaft to rotate which, in turn, causes the compressor to rotate and supply air to the air intake manifold of the engine at an increased pressure, i.e., at a pressure greater than ambient air pressure.

An element used within some turbochargers is a clutch. For example, FIG. 1 depicts a cross-sectional view of a prior art clutch and FIG. 2 depicts an exemplary location of a clutch location inside a turbocharger. FIG. 3 depicts a front view of the prior art clutch illustrating elements that are no longer required in the present invention. The prior art clutch 10 engages and disengages from a planetary gear set 12 depending on the speed at which the gears 14, 16, 17, 18, 20, 22 are turned. Such a clutch 10 is currently used in the Assignee's EMD engine. An example of such a clutch is the Assignee's EMD-compatible 645 turbocharger. FIGS. 1 and 3 are exemplary views of the 645 turbocharger.

In operation, at lower engine speeds and loads, the turbocharger 25, wherein the clutch 10, ring gear 34, sun gear 36, planetary gear set 12, carrier drive gear 14, turbo idler gear 16, and turbo drive gear 17 reside inside the turbocharger 25, must be mechanically driven since the exhaust gases do not contain enough energy to drive the turbocharger 25. However, at higher speeds, sufficient energy is provided to drive the turbocharger 25, thus requiring the clutch 10 to disengage the turbocharger rotor from the gear train 14, 16, 17, 18, 20, 22 of the locomotive. This allows the turbocharger 25 to respond to the input provided by the exhaust gases. A clutch designed for this purpose includes an annular-shaped camplate 30 that has a number of slots 31 formed in its outer periphery. The base of each slot defines a ramp that is in rolling contact with a cylindrical roller 32.

Thus, prior to having enough power to disengage, the ring gear 34 and the camplate 30, which are always locked together, are locked to the clutch support 42. When the turbocharger 25 is operating at a high enough speed, the increased torque from the sun gear 36 feeds through planetary gears 12 to rotate the ring gear 34 and camplate 30 in an unlocking direction. As also further disclosed in FIG. 1, a clutch housing 38, and turbine bearing 40 are provided. The clutch housing 38 now rotates around the clutch support 42 at a speed relative to the difference between the engine gear train speed and the turbine wheel revolutions per minute (RPM). During this overrunning condition, the clutch rollers 32 move to a wide end of the wedge-shaped pockets formed by the camplate ramps, thus unlocking the clutch.

Clutches are considered load-transmitting mechanisms and are susceptible to wear during the transition period when the clutch is engaging and disengaging, in which the input and output members are being coupled and uncoupled. Additionally, turbocharger clutches have many parts and may be expensive to maintain and service.

### BRIEF DESCRIPTION OF THE INVENTION

An embodiment of the present invention relates to a turbocharger system for an engine, e.g., a diesel engine in a locomotive or other vehicle. The turbocharger system comprises a turbocharger unit and a fixed gear assembly. The turbocharger unit comprises a compressor for providing compressed air to an intake of the engine, a turbine driven by an exhaust of the engine, and a shaft interconnecting the turbine and compressor. The turbine is coaxial with the compressor. The fixed gear assembly interconnects an engine gear train of the engine to the turbocharger unit for driving the turbocharger unit. There is no turbocharger clutch mechanism in the turbocharger system, engine, or vehicle generally. Thus, the fixed gear assembly operates to drive the turbocharger unit whenever the engine gear train is operational. (“Turbocharger clutch” or “turbocharger clutch unit” refers to a clutch device for mechanically engaging a turbocharger unit—compressor and turbine—with an engine output, for running the turbocharger using the mechanical output of the engine instead of or in addition to exhaust, and for mechanically disengaging the turbocharger unit from the engine output, for running the turbocharger using exhaust only.)

In an embodiment, the turbocharger clutch is replaced with the fixed gear assembly. The turbocharger is thereby operated whenever the engine gear train is running, without the possibility of selectively (or otherwise) disengaging the turbocharger from the engine. However, the overall turbocharger system is simplified by eliminating certain of the complex/moving components of a clutch, reducing costs for maintenance, service, and replacement.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a cross-sectional view of a prior art clutch taken along 1-1 of FIG. 3;

FIG. 2 depicts an exemplary location of a clutch inside a turbocharger;

FIG. 3 depicts a front view of the prior art clutch;

FIG. 4 depicts a cross-section view, taken along 4-4 of FIG. 5, of a fixed gear assembly according to an embodiment of the present invention;

FIG. 5 depicts a front view of the fixed gear assembly; and

FIG. 6 is a schematic diagram of a turbocharger system according to an embodiment of the present invention.

### DETAILED DESCRIPTION OF THE INVENTION

With reference to the figures, exemplary embodiments of the invention will now be described. Though this invention is described with respect to a locomotive engine system, the present invention is not intended to be limited to locomotive engine systems unless otherwise specified. Those skilled in the art will readily recognize that the present invention is applicable to other engine systems that utilize a turbocharger.

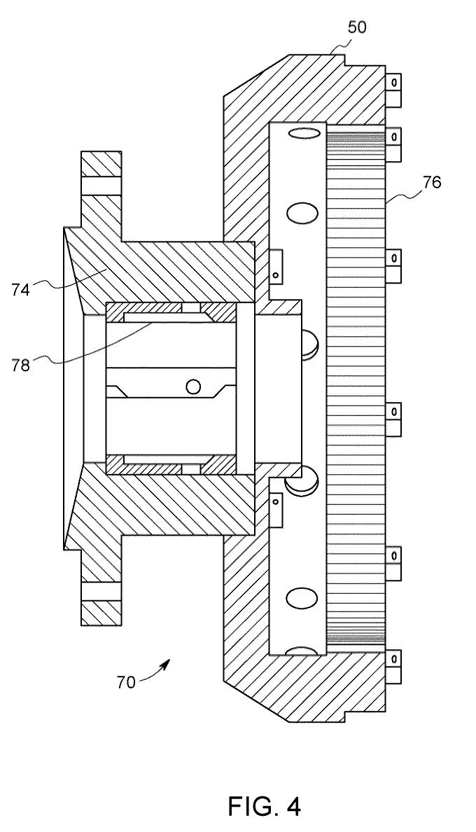

With reference to FIGS. 4-6, an embodiment of the present invention relates to a turbocharger system 90 for an engine 92, e.g., a diesel engine in a locomotive or other vehicle. The turbocharger system comprises a turbocharger unit 96 and a fixed gear assembly 72. The turbocharger unit 96 comprises a compressor 98 for providing compressed air 100 to an intake 102 of the engine 92, a turbine 104 driven by an exhaust 106 of the engine, and a shaft 80 interconnecting the turbine and compressor. The fixed gear assembly 72 interconnects an engine gear train 88 of the engine to the turbocharger unit for driving the turbocharger unit. There is no turbocharger clutch mechanism in the turbocharger system, engine, or vehicle generally. Thus, the fixed gear assembly 72 operates to drive the turbocharger unit whenever the engine and/or engine gear train is operational.

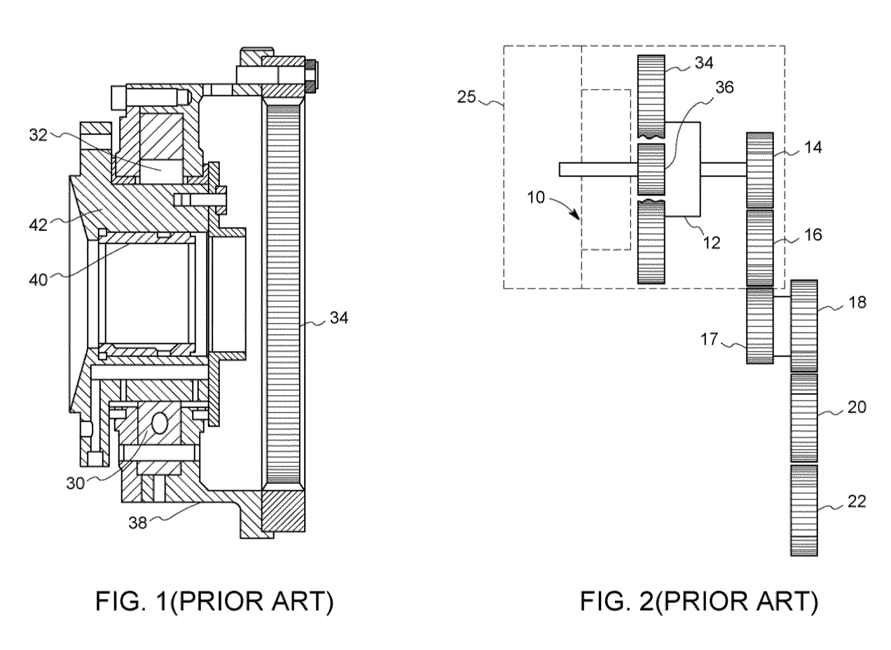

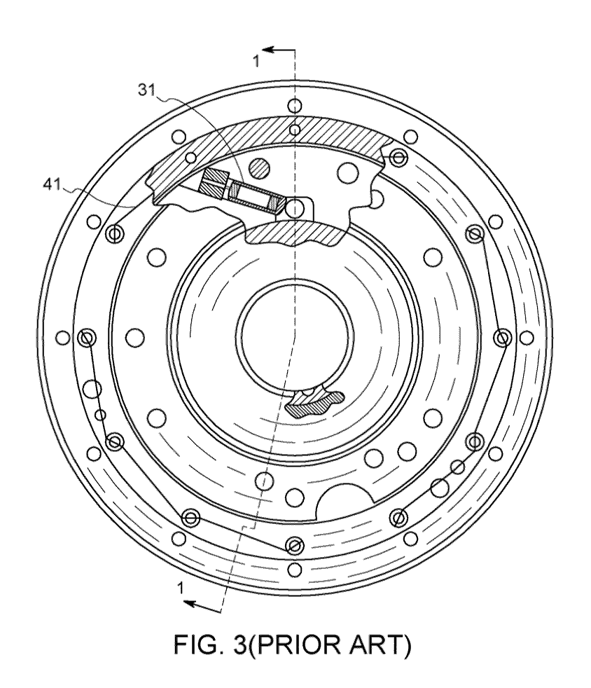

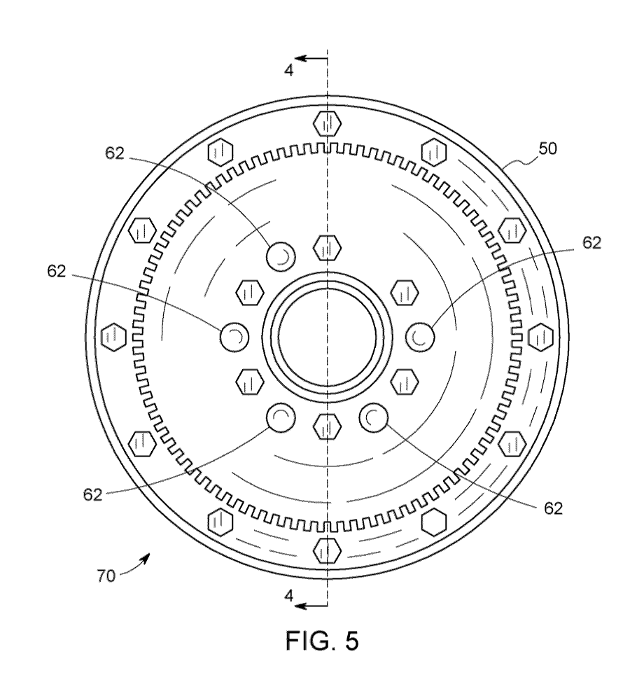

FIG. 4 depicts a cross-section view, taken along line 4-4 of FIG. 5, of a support unit portion 70 of the fixed gear assembly 72, according to an embodiment of the present invention. (“Fixed” means that the gears of the gear assembly do not disengage from one another during any operational modes of the assembly, and does not mean that the gears are prevented from rotating.) Comparing FIG. 4 to FIG. 3, and FIG. 4 to FIG. 1, it can be seen that the support unit 70 lacks the rollers 32, clutch camplate 30, springs 41, and slots 31 of the clutch 10. All other parts of the support unit 70 are fixed together. This embodiment reduces the number of movable parts in a turbocharger system, which results in cost savings for manufacturing, repair, and replacement. A replacement cost is realized because by having all elements fixed together, a reduction in component wear is achieved. Similar reasoning is also a basis for realizing savings in manufacturing and repair cost.

The support unit 70 comprises a shaft support 74, a ring gear 76, a turbine bearing 78, and a ring gear plate/unit 50. The ring gear plate 50 surrounds the ring gear 76 and connects to the shaft support 74. The turbine bearing 78 is positioned within a central bore (longitudinal opening) extending through the shaft support 74. The central bore of the shaft support 74 and the turbine bearing 78 are dimensioned to accommodate a turbocharger shaft 80.

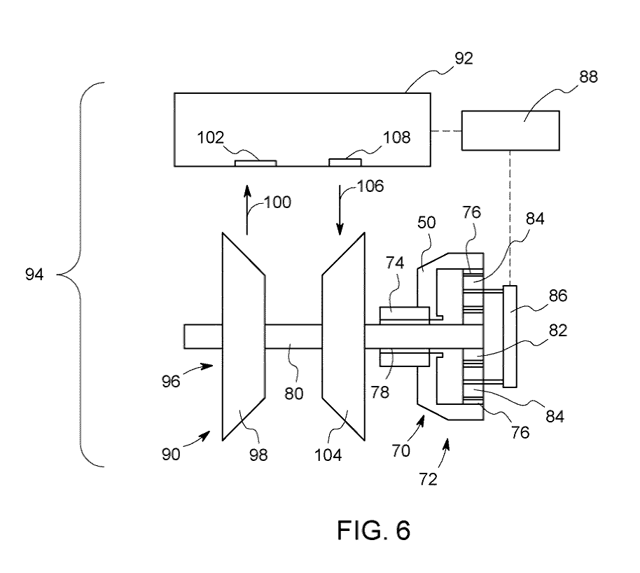

With reference to FIG. 6, the support unit 70 is part of the fixed gear assembly 72. In one embodiment, the fixed gear assembly 72 further comprises a sun gear 82 attached to the shaft 80, planet gears 84 that engage the sun gear 82 and the ring gear 76, and a planet carrier 86 connected to the planet gears 84. In operation, when the planet carrier 86 is rotated, it rotates and moves the planet gears 84 around the ring gear 76. (The ring gear 76 and the rest of the support unit 70 are fixed in place and do not rotate.) The planet gears 84 cause the sun gear 82 and thereby the shaft 80 to rotate. The planet carrier 86 is operably connected to an engine gear train 88, which is driven by an engine mechanical output (such as shown in FIG. 2, for example).

In an embodiment, as noted above, the fixed gear assembly 72 is part of a turbocharger system 90 for an engine 92, which itself is part of an engine system 94. (That is, the engine system 94 includes the engine 92, turbocharger system 90, engine gear train 88, etc.) The turbocharger system 90 comprises a turbocharger unit 96 and the fixed gear assembly 72. The turbocharger unit 96 comprises a compressor 98 for providing compressed air 100 to an intake 102 of the engine 92, a turbine 104 driven by exhaust 106 exiting an exhaust system 108 of the engine, and the shaft 80, which interconnects the turbine and compressor. The turbine is coaxial with the compressor. The fixed gear assembly 72 interconnects the engine gear train 88 of the engine 92 to the turbocharger unit 96 for driving the turbocharger unit. There is no turbocharger clutch mechanism in the turbocharger system and engine. Thus, the fixed gear assembly 72 operates to drive the turbocharger unit 96 whenever the engine gear train 88 is operational.

As noted, the fixed gear assembly acts as a replacement to a turbocharger clutch, providing a mechanical driving connection between the engine and turbocharger but without the functionality of a possible disconnect or disengagement of the two. Thus, the turbocharger is operated whenever the engine gear train is running, without the possibility of selectively (or otherwise) disengaging the turbocharger from the engine. Since the turbine 104 is still driven by exhaust 106, overrunning may be prevented by modifying the engine 92 (e.g., through an engine control unit/ECU software change) to limit exhaust output. As should be appreciated, embodiments of the present invention may be beneficial where it is desired to improve the mechanical reliability of locomotives or other vehicles with existing turbocharger systems, and to lower maintenance costs, but where it is not possible (and/or desirable) to replace the entire turbocharger system of the vehicle.

Another embodiment relates to a method for converting a turbocharger system of an engine. The turbocharger system comprises a turbocharger unit having a compressor for providing compressed air to an intake of the engine, a turbine coaxial with the compressor and driven by an exhaust of the engine, and a shaft interconnecting the turbine and compressor. The conversion method comprises replacing a turbocharger clutch unit of the turbocharger system with a fixed gear assembly (such as an embodiment of the fixed gear assembly described herein), and connecting the fixed gear assembly to the turbocharger unit and to an engine gear train of the engine. The fixed gear assembly operates to drive the turbocharger unit whenever the engine gear train is operational.

Once the fixed gear assembly is installed, in place of a turbocharger clutch unit or otherwise, there will be no turbocharger clutch in the vehicle, engine system, turbocharger system, or otherwise. Thus, it is not possible to disengage the turbocharger unit from the engine, for running the turbocharger using exhaust only. As to when the turbocharger unit is actually operational, this will depend on the configuration of the engine. In one embodiment, the turbocharger unit operates whenever the engine is running (combusting fuel). In another embodiment, the turbocharger unit operates whenever the engine gear train is operational, which may include a mode where the engine is running but the engine gear train is not running. For example, the engine gear train may be driven by a propulsion/traction output of the traction/engine system of the vehicle, where the propulsion/traction output does not run when the engine is idling. Thus, in another embodiment, the turbocharger unit operates whenever the vehicle is in a propulsion mode and moving along a route.

In one embodiment of the method for converting a turbocharger system of an engine, the fixed gear assembly that replaces a turbocharger clutch unit has the same profile configuration as the turbocharger clutch unit. In one aspect, “profile configuration” refers to the overall physical expanse of the clutch unit or fixed gear assembly, with respect to engine system; thus, when the clutch unit and fixed gear assembly are characterized as having the same profile configuration, in one aspect this means that the fixed gear assembly fits in the same space as previously occupied by the clutch unit, and/or that the engine system does not require spatial reconfiguration (e.g., different sized engine components) to accommodate the fixed gear assembly in place of the clutch unit. In another aspect, “profile configuration” alternatively or in addition refers to an input and output of the clutch unit or gear assembly, with respect to engine system; thus, when the clutch unit and fixed gear assembly are characterized as having the same profile configuration, in another aspect this alternatively or in addition means that the fixed gear assembly is a “drop-in” replacement for the clutch unit, in terms of how the clutch unit and fixed gear assembly interface with the engine gear train and turbocharger unit (for example, it may be the case that the clutch unit is removed, and the fixed gear assembly installed in its place, without having to modify or replace any of the component portions of the engine gear train or turbocharger unit). In these embodiments, the fixed gear assembly may include various components that have the same outer shape as similar components in a clutch unit, and/or various components that are the same as those in a clutch unit, e.g., the shaft support 74 has the same outer shape and/or interior bore dimension as the clutch support 42, the turbine bearing 78 is the same as the turbine bearing 40, the ring gear plate 50 has the same or similar outer dimensions as the clutch housing 38, and the like.

FIG. 5 depicts a front view of another embodiment of the fixed gear assembly. As illustrated, connectors, such as but not limited to dowel pins or other pins 62, are provided between the clutch support (not shown) and ring gear plate 50. In an exemplary embodiment, five dowel pins or other pins are provided. The dowel pins or other pins 62 provide improved torque-carrying capability as they carry the torque load applied through the planetary gear train 12. (By “improved,” it is meant more torque-carrying capability than if the pins were not present.)

According to one aspect, the fixed gear design of the present invention in effect converts a vehicle turbocharger into a supercharger. Turbochargers and superchargers are both used to compress and so increase the mass of air that is available for combustion in an engine, and thereby boost the power output. A supercharger is a positive displacement, mechanically driven unit with intermeshing rotors, while a turbocharger has an exhaust driven turbine wheel connected to a compressor wheel in the intake air ducting. At lower revolutions per minute (RPMs), a supercharger provides greater boost, but at higher RPMs, where engine exhaust gas can be better utilized, this is not necessarily true.

Furthermore, embodiments of the present invention provide better reliability for switcher applications. A switcher is usually a lower-powered locomotive used in railroad yards to move unpowered rail cars (i.e., rail cars that do not have an on-board propulsion source). Sometimes they are specialty locomotives, but often times they are older de-rated locomotives that have been removed from road service. In switch applications, the turbocharger system usually will not come on and off the clutch (due to low engine operation levels), meaning they are good candidates for the conversion method described herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person skilled in the art to practice the embodiments of invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present invention will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described turbocharger system and method, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A turbocharger system for an engine, the turbocharger system comprising:
a turbocharger unit comprising a compressor for providing compressed air to an intake of the engine, a turbine driven by an exhaust of the engine, and a shaft interconnecting the turbine and compressor, wherein the turbine is coaxial with the compressor; and
a fixed gear assembly interconnecting an engine gear train of the engine to the turbocharger unit for driving the turbocharger unit, wherein there is no turbocharger clutch mechanism in the turbocharger or engine, such that the fixed gear assembly operates to drive the turbocharger unit whenever the engine gear train is operational.

2. The turbocharger system of claim 1 wherein the fixed gear assembly comprises a support with an inner cavity formed therein, a turbine bearing fixed within the inner cavity of the support, an annular ring gear plate with a back side of the ring gear plate being fixed to an end of the support, and a ring gear fixed within the ring gear plate.

3. The turbocharger system of claim 2 wherein the fixed gear assembly further comprises a pin disposed through the support and ring gear plate so as to fix the support and the ring gear plate together.

4. The turbocharger system of claim 3 wherein the pin provides an improved torque-carrying capability.

5. The turbocharger system of claim 2 wherein a plurality of pins are disposed through the support and ring gear plate so as to fix the support and the ring gear plate together.

6. The turbocharger system of claim 5 wherein the pins provide an improved torque-carrying capability.

7. The turbocharger system of claim 5 where the plurality of pins comprises five pins.

8. The turbocharger system of claim 1 wherein the fixed gear assembly comprises a planetary gear unit having a ring gear, a plurality of planet gears that travel around the ring gear under driving action of the engine gear train, and a sun gear driven by the planet gears, the sun gear being connected to the shaft.

9. A turbocharger system for a locomotive, comprising:
a locomotive engine having an air intake, an exhaust system, and a gear train;
a turbocharger unit connected to the engine and comprising a compressor for providing compressed air to the air intake, a turbine driven by exhaust from the exhaust system, and a shaft interconnecting the turbine and compressor, wherein the turbine is coaxial with the compressor; and
a fixed gear assembly interconnecting the engine gear train to the turbocharger unit for driving the turbocharger unit;
wherein there is no turbocharger clutch mechanism in the locomotive engine and turbocharger unit, such that the fixed gear assembly operates to drive the turbocharger unit whenever the engine is operational.

10. The turbocharger system of claim 9 wherein the fixed gear assembly comprises a support with an inner cavity formed therein, a turbine bearing fixed within the inner cavity of the support, an annular ring gear plate with a back side of the ring gear plate being fixed to an end of the support, and a ring gear fixed within the ring gear plate.

11. The turbocharger system of claim 9 wherein the fixed gear assembly comprises a planetary gear unit having a ring gear, a plurality of planet gears that travel around the ring gear under driving action of the engine gear train, and a sun gear driven by the planet gears, the sun gear being connected to the shaft.

12. A method of converting a turbocharger system of an engine, wherein the turbocharger system comprises a turbocharger unit having a compressor for providing compressed air to an intake of the engine, a turbine driven by an exhaust of the engine, and a shaft interconnecting the turbine and compressor, wherein the turbine is coaxial with the compressor, the method comprising:
replacing a turbocharger clutch unit of the turbocharger system with a fixed gear assembly; and
connecting the fixed gear assembly to the turbocharger unit and to an engine gear train of the engine, wherein the fixed gear assembly operates to drive the turbocharger unit whenever the engine gear train is operational.

13. The method of claim 12, wherein the fixed gear assembly has a profile configuration that is the same as a profile configuration of the turbocharger clutch unit.
